(19) United States
(12) Patent Application Publication
(10) Pub. No.: US 2025/0027245 A1
(43) Pub. Date: Jan. 23, 2025

(54) AUTOMATIC AIR DRYING OF CLOTHES WASHER

(71) Applicant: Haier US Appliance Solutions, Inc., Wilmington, DE (US)

(72) Inventors: Haitian Hu, Louisville, KY (US); Hairong Li, Louisville, KY (US)

(21) Appl. No.: 18/353,703

(22) Filed: Jul. 17, 2023

(51) Int. Cl. D06F 33/32; D06F 23/02; D06F 34/04; D06F 34/18; D06F 34/20; D06F 34/28; D06F 37/04; D06F 37/30; D06F 39/14; G06V 20/50

(52) U.S. Cl. CPC D06F 33/32; D06F 23/02; D06F 34/04; D06F 34/18; D06F 34/20; D06F 34/28; D06F 37/04; D06F 37/304; D06F 39/14; G06V 20/50; D06F 2101/14; D06F 2103/04; D06F 2103/38; D06F 2103/40

(57) ABSTRACT

A front load laundry appliance includes a basket supported for rotation within a cabinet, a door rotatable between an open position and a secured closed position to provide selective access to the basket, and a controller. The controller is configured to initiate an air dry mode for the laundry appliance when a set of conditions exist for the laundry appliance. In the air dry mode, the rotating basket draws a flow of ambient air through the basket to a vent.

### FIELD OF THE INVENTION

The present disclosure relates generally to laundry appliances, particularly to connected front load washing machines.

### BACKGROUND OF THE INVENTION

Laundry appliances (or washing machines) in general are sensitive to mold growth due to the damp environment present in and around the machines. Front load laundry appliances are particularly vulnerable due in part to the rubber door seal which may provide an environment favorable to mold growth. For at least aesthetic and health reasons, mold growth on a laundry appliance is not desirable.

One method for reducing mold growth on front load laundry appliances includes leaving the laundry appliance door open for a period of time to allow the evaporation of water trapped in or on the door seal or in the drum. However, for some users, leaving the laundry appliance door open for a period of time sufficient to dry the seal by evaporation is not practical. Accordingly, improvements to methods of drying the door seal and drum of front loading laundry appliances may be desirable.

### BRIEF DESCRIPTION OF THE INVENTION

Aspects and advantages of the invention will be set forth in part in the following description, may be apparent from the description, or may be learned through practice of the invention.

In one exemplary aspect, a laundry appliance comprising a cabinet including a front panel, the front panel defining an opening, a basket supported for rotation within the cabinet, the basket defining and interior space accessible through the opening and configured to receive laundry articles, a motor assembly mechanically coupled to the basket and configured to selectively rotate the basket, a door assembly rotatably mounted to the cabinet, the door assembly rotatable between an open position allowing access to the opening and a secured closed position blocking access to the opening, and a controller in operative communication with the basket and the door assembly is presented. The controller is configured to, determine the basket is empty of laundry articles, determine the door assembly is in the secured closed position, determine a laundry appliance idle time, and initiate an air dry mode for the laundry appliance during the laundry appliance idle time.

In another exemplary aspect, a method of operating a laundry appliance comprising a cabinet including a front panel defining an opening, a basket supported for rotation within the cabinet, the basket defining and interior space accessible through the opening and configured to receive laundry articles, a door assembly rotatably mounted to the cabinet, the door assembly rotatable between an open position and a secured closed position blocking access to the opening, a controller, and user input devices in operative communication with the controller is presented. The method comprises determining the basket is empty of laundry articles, determining the door assembly is in the secured closed position, determining a laundry appliance idle time, and initiating an air dry mode for the laundry appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a laundry appliance in accordance with an embodiment of the present disclosure;

FIG. 2 provides a side sectional view taken along II-II of the laundry appliance of FIG. 1; and

FIG. 3 illustrates a method for operating a laundry appliance in accordance with an embodiment of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

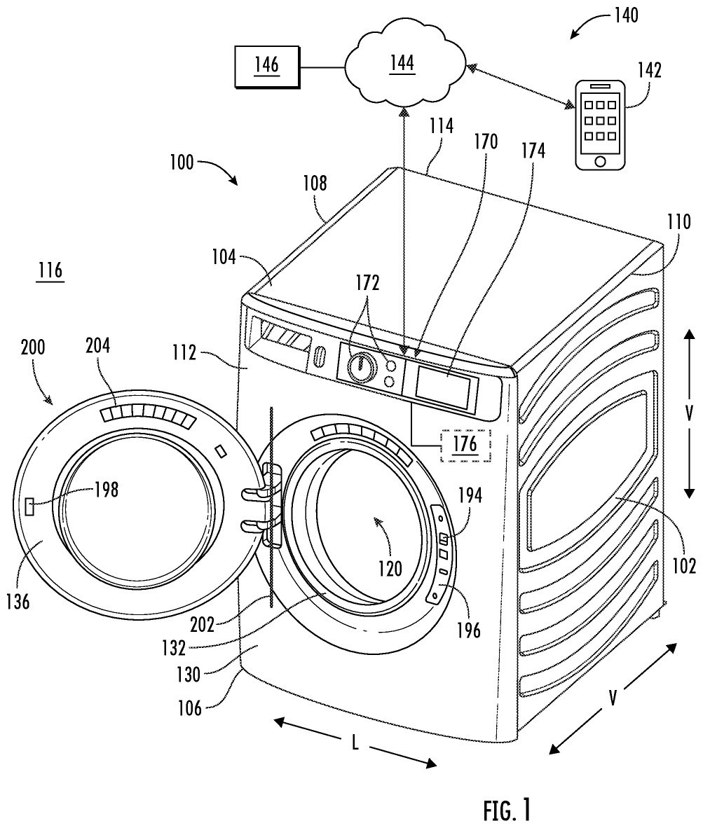

Turning to the figures, FIG. 1 provides a front perspective view of a horizontal axis or front load laundry appliance 100 (commonly referred to as a front load washing machine) in accordance with exemplary embodiments of the present invention. As illustrated in the figure, the laundry appliance 100 generally defines a vertical direction V, a lateral direction L, and a transverse direction T, each of which is mutually perpendicular, such that an orthogonal coordinate system is generally defined. Laundry appliance 100 includes a cabinet 102 that extends between a top 104 and a bottom 106 along vertical direction V, between a left side 108 and a right side 110 along the lateral direction L, and between a front 112 and a rear 114 along the transverse direction T. The cabinet 102 includes a front panel 130 defining an opening 132 providing access to the interior of the cabinet 102.

A control panel 170 including a plurality of input selectors 172 is coupled to front panel 130. Input selectors 172 may be one or more selector knobs as illustrated in FIG. 1 or any combination of buttons and selector knobs appropriate for user manipulation to control the operation of the laundry appliance 100. For example, a user may manipulate input selectors 172 to select various laundry appliance cycles such as washing, drying, or washing followed by drying in a combination machine. Treatment cycles for treating articles in basket 120 may also be selected or programmed. Control panel 170 and input selectors 172 collectively form a user interface input for user selection of machine cycles and features. For example, in one embodiment, a display 174 indicates selected features, a countdown timer, and/or other data items of interest to machine users.

Operation of laundry appliance 100 is controlled by a processing device or controller 176 that is operatively coupled to control panel 170 and input selector(s) 172 for user selectable laundry appliance cycles and features. In response to user manipulation of control panel 170 and input selector(s) 172, controller 176 operates the various components of laundry appliance 100 to execute selected machine cycles and features.

Controller 176 may include a memory and a microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 176 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 170 and other components of laundry appliance 100 may be in communication with controller 176 via one or more signal lines or shared communication busses.

Input selector(s) 172 may be manipulated by a user to instruct the laundry appliance 100 to perform a particular laundry cycle or a series of cycles from a plurality of cycle options. For example, a wash cycle may be selected to be followed by an automatic air dry cycle after the laundry load is removed from the basket 120 and the door assembly or door 200 is closed. Here, “automatic” is used to indicate the air dry cycle starts and runs after a wash cycle, for example, without further user manipulation of the input selectors 172. Characteristics of the wash and dry cycles may be selected according to the construction or composition of the articles to be laundered, the intensity of the laundry process sought, or the number of articles present to be treated. Feedback may be provided in response to the user's input on the display 174 and may include indication of the cycle selected, a cycle time display, or messages concerning the operation of the laundry appliance 100.

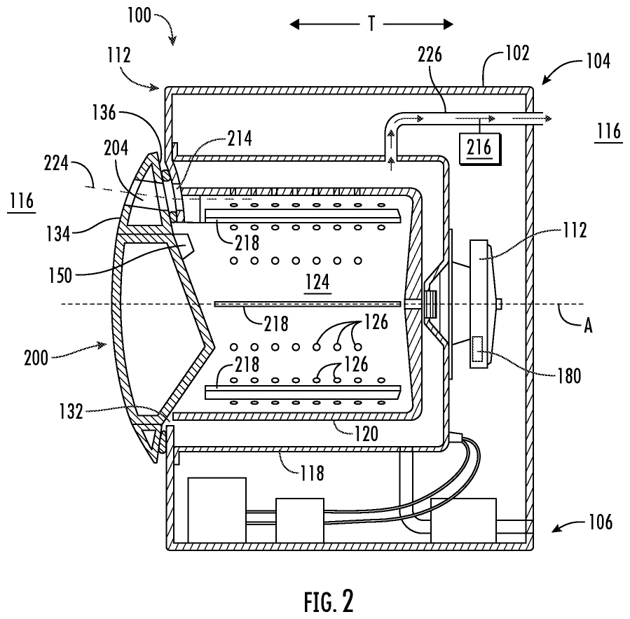

As may be best seen in FIG. 2, drum 118 is positioned in the cabinet 102 and is accessible through the opening 132. Drum 118 may generally be a watertight vessel sealed against fluid leaks to the front panel 130. In embodiments, a basket 120 is rotatably mounted within the drum 118 such that the basket 120 is supported for rotation about axis A, generally parallel to transverse direction T. A motor assembly 122 is mechanically coupled to basket 120 and configured to selectively rotate basket 120 during various laundry cycles. According to some embodiments, motor assembly 122 is in operative communication with controller 176 to rotate the basket at a plurality of rotational speeds depending on the selected laundry cycle. In some embodiments, the motor assembly 122 includes a torque measurement device 180, a clutch, gearing, and other mechanical components to facilitate rotation of the basket.

The basket 120 defines an interior space 124 suitable for the receipt and treatment (for example washing) of a load of laundry articles. For example, a load of clothes may be placed within the basket 120 and subjected to agitation through rotation of the basket 120 and one or more ribs 128 with a wash fluid. Fluids, such as wash fluid and air, may flow between the interior space 124 of the basket 120 and the drum 118 through a plurality of perforations 126.

Returning to FIG. 1, the exemplary front loading laundry appliance 100 comprises a door assembly or door 200 that may be positioned over opening 132 and is rotatably mounted to front panel 130 of the cabinet 102. More specifically appliance door assembly 200 is rotatable about door axis 202 that is substantially parallel to the vertical direction V. In this manner door 200 permits selective access to opening 132 and basket 120 by being rotatable between an open position (FIG. 1) allowing access and a closed position (FIG. 2) blocking access to opening 132.

In embodiments, the door assembly 200 includes a door latch 198 to engage with a door latch plate 196 to facilitate securing door assembly 200 in a secured closed position (FIG. 2), and a sensor 194 configured to monitor the door latch and latch plate engagement and signal the controller 176. The door latch 198 may engage with a latch plate 196 formed on or mounted to a portion of the front panel 130 adjacent to the opening 132. The sensor 194 may be configured to detect the door assembly 200 in a secured closed position. In embodiments, the sensor 194 may be in operative communication with the controller 176 to confirm the door assembly 200 is secured closed, i.e., the door latch 198 and the latch plate 196 are fully engaged, before initiation certain laundry operations.

As illustrated in FIGS. 1 and 2, door assembly 200 defines a door vent 204 formed through the door assembly 200 from the outer face 134 (FIG. 2) to the inner face 136 (FIG. 1). The door vent 204 may facilitate free flow of air from the outside environment 116 through the door assembly 200 to the inner face 136. In other embodiments, the flow of air may be controlled by selectively moveable louvers in the vent to provide a controlled flow or air.

As can be seen in the exemplary embodiment of FIG. 1, the front panel 130 defines a cabinet inlet vent 214 located adjacent to opening 132. When the door assembly 200 is in the closed position as illustrated in FIG. 2, door vent 204 is in fluid communication with cabinet inlet vent 214. As illustrated in FIG. 2, the cabinet inlet vent 214 is fluidly coupled to the drum 118 defining a flow path 224 into the drum 118 when the door assembly 200 is in the closed position. As such, an inlet flow path 224 is defined through the door assembly 200, the cabinet inlet vent 214, and into the basket 120.

Perforations 126 in the basket wall facilitates fluid flow from the interior space 124 into the drum 118. The exemplary embodiment of FIG. 2 includes an exhaust vent 226 fluidly coupled to the drum 118 and in fluid communication with the external atmosphere 116. Accordingly, as in the illustrated embodiment, flow path 224 extends from the door vent 204, the cabinet inlet vent 214, the basket 120, into the drum 118, and to the external atmosphere 116.

Ribs 218 extending into the interior space 124 of basket 120 are configured to, among other things, urge an air flow along air flow path 224 trough the basket 120. When rotating, ribs 218 urge the air flow through the perforations 126 into the drum 118. Exhaust vent 226 provides a path for the air flow to exit the drum 118. The flow of air entering the door vent 204 is typically dryer than the air in the basket 120 and tub 118. As the air flows along flow path 224, it picks up moisture from the relatively humid air in the basket and tum 120, 118, drying the interior space 124 and laundry appliance 100 components that may have come in contact with wash fluids during a wash cycle.

Referring still to FIG. 1, a schematic diagram of an external communication system 140 will be described according to an exemplary embodiment of the present subject matter. In general, external communication system 140 is configured for permitting interaction, data transfer, and other communications between laundry appliance 100 and one or more external devices. For example, this communication may be used to provide and receive operating parameters, user instructions or notifications, performance characteristics, user preferences, or any other suitable information for improved performance of appliance 100. In addition, it should be appreciated that external communication system 140 may be used to transfer data or other information to improve performance of one or more external devices or appliances and/or improve user interaction with such devices.

For example, external communication system 140 permits controller 176 of laundry appliance 100 to communicate with a separate device external to laundry appliance 100, referred to generally herein as an external device 142. As described in more detail below, these communications may be facilitated using a wired or wireless connection, such as via a network 144. In general, external device 142 may be any suitable device separate from laundry appliance 100 that is configured to provide and/or receive communications, information, data, or commands from a user. In this regard, external device 142 may be, for example, a personal phone, a smartphone, a tablet, a laptop or personal computer, a wearable device, a smart home system, or another mobile or remote device.

In addition, a remote server 146 may be in communication with laundry appliance 100 and/or external device 142 through network 144. In this regard, for example, remote server 146 may be a cloud-based server 146, and thus may be located at a distant location, such as in a separate state, country, etc. According to an exemplary embodiment, external device 142 may communicate with a remote server 146 over network 144, such as the Internet, to transmit/receive data or information, provide user inputs, receive user notifications or instructions, interact with or control laundry appliance 100, etc. In addition, external device 142 and remote server 146 may communicate with laundry appliance 100 to communicate similar information.

In general, communication between laundry appliance 100, external device 142, remote server 146, and/or other user devices or appliances may be carried using any type of wired or wireless connection and using any suitable type of communication network, non-limiting examples of which are provided below. For example, external device 142 may be in direct or indirect communication with laundry appliance 100 through any suitable wired or wireless communication connections or interfaces, such as network 144. For example, network 144 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 140 is described herein according to an exemplary embodiment of the present subject matter. However, it should be appreciated that the exemplary functions and configurations of external communication system 140 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

In embodiments of the present disclosure, laundry appliance 100 may be structured such that controller 176 is configured to operate features of laundry appliance 100. For example, the controller 176 may initiate certain operations without user instructions immediately prior to initiation of the operation. In some cases, a user may provide the controller 176 with the required permissions to automatically initiate, at any time in the future, one or more laundry appliance features or modes of operation if a certain set of conditions has been satisfied. According to embodiments of the present disclosure, an automatic air dry mode may be initiated by the controller 176 if the controller determines the basket 120 is empty of laundry articles, the door assembly 200 is in the secured closed position, and the laundry appliance 100 is determined to be in an idle time period.

In some embodiments, the basket can be determined to be empty of laundry articles using a vision system or camera 150 positioned with a field of view of the interior space 124 of the basket 120. In the exemplary embodiment of FIG. 2, the camera 150 is mounted to the door assembly 200, although other embodiments mount the camera 150 in other suitable locations. The camera 150 may take any suitable number or sequence of two-dimensional images, videos, or other visual representations of the interior space 124 at suitable times during or following laundry appliance cycles. The images may be compared to a stored reference image of the interior space 124 in a known empty condition. Any suitable method of observation, analysis, image decomposition, feature extraction, or image classification, of one or more images, videos, or other visual representations of an object (i.e., any image analysis process) may be used to compare an image recorded by the camera 150 with the reference image to determine if the basket 120 is empty.

Alternatively or additionally, the controller 176 may signal the motor assembly 122 to rotate the basket 120 and measure the torque required to determine if the basket 120 is empty of laundry articles. According to embodiments, the torque measurement device 180 in the motor assembly 122 compares the torque required to rotate the basket 120 at a selected time after a laundry operation with a reference torque. The reference torque may be that torque, calculated or otherwise determined, sufficient to rotate a known empty basket 120. If the measured torque is within a predetermined range of the reference value, the controller may determine the basket is empty of laundry articles.

In determining if the door assembly 200 is in a secured closed position, the door latch 198, the latch plate 196, and the sensor 194 may cooperate to signal the controller 176 of the door condition. In particular, the sensor 194 may be in operative communication with the controller 176. When the door latch 198 engages the latch plate 196, sensor 194 may signal the controller that the door is secured in the closed position.

Idle time for laundry appliance 100 may be a period of time during which the laundry appliance 100 will not be used for laundry operations, for example washing operations. In some embodiments, the idle time may be determined by user input. For example, a user may manipulate user input devices or selectors 172 on the user interface or control panel 170 to select an idle time for the laundry appliance 100. During that idle time, the laundry appliance 100 will not be used for laundry operations.

In other embodiments, a historical record of laundry appliance operations may be stored in a memory location. Included in the historical record may be periods of time when the laundry appliance was idle. From the record, the controller may be able to determine one or more periods of time when the laundry appliance will likely be idle and identify those periods as laundry appliance idle times.

When the conditions are met (i.e., basket 120 is empty, door assembly 200 is in secured closed position, and laundry appliance 100 is in an idle time) the controller may initiate an automatic air dry mode for the laundry appliance during the idle time. In the automatic air dry mode, the controller 176 signals the motor 122 to rotate the basket 120 for a predetermined length of time. As the basket rotates, ribs 218 urge the flow of ambient air from the outside environment 116 to flow along flow path 224, through the basket 120 and drum 118 and out the exhaust vent 226. A humidity sensor 216 in the flow path 224 monitors the humidity in the air flow. As long as the humidity in the air flow is at or above a predetermined level, the controller signals the motor 122 to rotate the basket for the predetermined length of time. During each successive time period of rotation, the humidity sensor is sampling the air for humidity level. When the humidity in the air flow reaches a predetermined level, the controller terminates the automatic air dry mode. The automatic air dry mode may alternately be interrupted or terminated by user manipulation of the input selectors at any time during the airdry mode. Such manipulations may return the laundry appliance 100 to a normal mode of laundry operation.

In some embodiments, the network 144 instructs the controller 176 to operate the laundry appliance. For example, in determining the basket 120 is empty, the camera 150 may communicate the image(s) for analysis to the network 144, through the controller 176. The image analysis may be performed at the network 144 and the determination communicated to the controller 176. Similarly, torque measurement device 180 may communicate the measured torque to the network 144 through the controller 176. The network 144 may compare the reference torque to the measured torque, determine if the basket 120 is empty, and communicate the determination to the controller 176.

The network 144 may likewise make the determination if the door assembly in the secured closed position and communicate the determination to the controller 176.

In determining laundry appliance idle time, the network 144 may include at least one of a memory location and an external device 142. The memory location may include the historical record of laundry appliance operations, and may use the record to communicate to the controller the determined laundry appliance idle time(s). The network 144 may have a memory location including a user calendar which may comprise a laundry schedule. The network 144 may determine laundry appliance idle time from the information included in the laundry schedule.

In embodiments in which the network includes an external device 142, determining idle time may include user input at the external device. For example, a user may enter at the external device 142 anticipated or scheduled time periods when the laundry appliance 100 will be idle. Accordingly, the automatic air dry mode may be scheduled during the user determined laundry appliance idle time. The automatic air dry mode may be interrupted or terminated at any time with user input at the external device 142 or a the input selectors 172 at the control panel 170. Termination will return the laundry appliance 100 to normal mode of laundry operations.

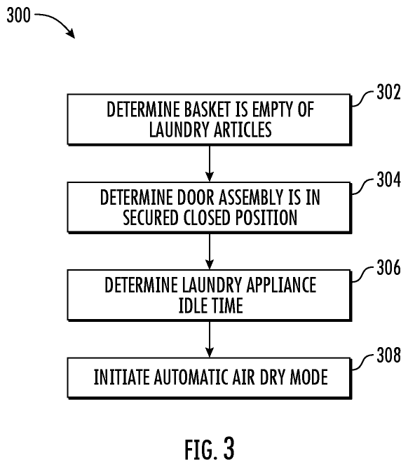

Now that the construction of a laundry appliance in accordance with this disclosure has been presented, an exemplary method 300 of operation for a laundry appliance will be described with reference to FIG. 3. Method 300 begins at 302 with determining if the basket is empty of laundry articles. In embodiments, this determination can be made with a vision system or camera and image analysis which may be performed at the laundry appliance or a ta network in communication with the laundry appliance. In other embodiments, this determination may be reached using a motor and a torque measurement device. The measured torque may be compared to a reference torque corresponding to a calculated or empirically determined torque required to rotate a known empty basket. The comparison may be performed at the laundry appliance controller or at a network in communication with the controller.

The method advances to 304 at which the door assembly is determined to be in a secured closed position. In embodiments, the determination can be made using a door position sensor, a latch on the door, and a latch plate on a front panel of the laundry appliance cabinet. The sensor may communicate to the controller a signal corresponding to the condition of the door closure.

At 306, a laundry appliance idle time is determined. This determination may be made from user input at the input selectors on the control panel or at an external device included in a network in communication with the controller. In other embodiments, the laundry appliance idle time may be determined from a record of historical laundry appliance operations stored at a memory location in the controller or in the network. From the record, patterns or historical use can be recognized and used to determine future idle times. In still other embodiments, the network may include a user calendar with a laundry schedule. Laundry appliance idle time may be determined from the user input laundry schedule.

At 308, an automatic air dry mode may be initiated when steps 302, 304, and 306 are satisfied. For example, if it is determined that the basket is empty of laundry articles, that the door assembly is in a secured closed position, and the laundry appliance is in a determined idle time, the air dry mode may be initiated. In the air dry mode, the controller 176 signals the motor assembly 122 to rotate the basket 120 within the drum 118. The rotating drum, in particular the ribs 218 extending into the interior space 124, urge a flow of ambient air from the outside environment 116 through the door assembly 200, into the cabinet inlet vent 214, through the basket 120 and drum 118, and back to exhaust vent 226. Humidity sensor 216 samples the air flow for moisture content to determine completion of the automatic air dry mode. When the humidity sensor 216 senses a humidity level below a prescribed value, the controller 176 is signaled and the air dry mode terminates.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A laundry appliance comprising:
a cabinet including a front panel, the front panel defining an opening;
a basket supported for rotation within the cabinet, the basket defining and interior space accessible through the opening and configured to receive laundry articles;
a motor assembly mechanically coupled to the basket and configured to selectively rotate the basket;
a door assembly rotatably mounted to the cabinet, the door assembly rotatable between an open position allowing access to the opening and a secured closed position blocking access to the opening; and
a controller in operative communication with the basket and the door assembly, wherein the controller is configured to:
determine the basket is empty of laundry articles;
determine the door assembly is in the secured closed position;
determine a laundry appliance idle time; and
initiate an air dry mode for the laundry appliance during the laundry appliance idle time.

2. The laundry appliance of claim 1, wherein:
the laundry appliance further comprises a camera assembly positioned with a field of view of the interior space of the basket; and
determining the basket is empty of laundry articles comprises image analysis of an image of the interior space of the basket.

3. The laundry appliance of claim 1, wherein:
the motor assembly includes a torque measurement device; and
determining the basket is empty of laundry articles comprises a measurement of torque required to rotate the basket.

4. The laundry appliance of claim 1, wherein:
the door assembly comprises a door sensor configured to detect the door assembly in the secure closed position; and
determining the door assembly is in the secured closed position comprises receiving a signal from the door sensor corresponding to the door assembly in the secured closed position.

5. The laundry appliance of claim 1, wherein the laundry appliance further comprises a user interface panel including user input devices in operative communication with the controller; and
further wherein determining the laundry appliance idle time comprises user manipulation of the user input devices.

6. The laundry appliance of claim 1, wherein the controller is further in operative communication with an external communication system including a network, the network comprising at least one of a memory and an external device.

7. The laundry appliance of claim 6, wherein the memory includes an historical record of laundry appliance operations; and
further wherein determining the laundry appliance idle time comprises recognizing a pattern of laundry appliance idle time in the historical record of laundry appliance operations.

8. The laundry appliance of claim 6, wherein determining the laundry appliance idle time comprises user input at the external device.

9. The laundry appliance of claim 6, wherein the network further comprises a user calendar including a laundry schedule; and
wherein determining the laundry appliance idle time comprises use of laundry schedule information included in the laundry schedule.

10. The laundry appliance of claim 1 further comprising a vent facilitating fluid communication between an ambient air and the interior space of the basket; and
wherein initiating the air dry mode comprises energizing the motor assembly by the controller to rotate the basket, the rotating basket urging a flow of ambient air through the vent and into the basket.

11. A method of operating a laundry appliance comprising a cabinet including a front panel defining an opening, a basket supported for rotation within the cabinet, the basket defining and interior space accessible through the opening and configured to receive laundry articles, a door assembly rotatably mounted to the cabinet, the door assembly rotatable between an open position and a secured closed position blocking access to the opening, a controller, and user input devices in operative communication with the controller, the method comprising:
determining the basket is empty of laundry articles;
determining the door assembly is in the secured closed position;
determining a laundry appliance idle time; and
initiating an air dry mode for the laundry appliance.

12. The method of claim 11, wherein determining the basket is empty of laundry articles comprises image analysis of an image taken by a camera having a field of view of the interior space of the basket.

13. The method of claim 11, wherein determining the basket is empty of laundry articles comprises a measurement of torque required to rotate the basket, the torque applied by a motor assembly including a torque measurement device, the motor assembly mechanically coupled to the basket and configured to impart a torque to rotate the basket.

14. The method of claim 11, wherein determining the door assembly is in the secured closed position comprises receiving a signal from a door sensor, the signal corresponding to the door assembly in the secured closed position.

15. The method of claim 11, wherein determining the laundry appliance idle time comprises a user manipulation of the user input devices.

16. The method of claim 11, wherein determining the laundry appliance idle time comprises recognizing a pattern of historical laundry appliance operations stored in an external communication system including a network memory and an external device, the external communication system in operative communication with the controller.

17. The method of claim 16, wherein the pattern of historical laundry appliance operations includes periods of time that the laundry appliance is idle.

18. The method of claim 16, wherein determining the laundry appliance idle time comprises user input at the external device.

19. The method of claim 16, wherein determining the laundry appliance idle time comprises use of laundry schedule information included on a user calendar in the network memory.

20. The method of claim 16, wherein user manipulation of one of the user input devices and the external device may interrupt the air dry mode.
